(19) United States
(12) Patent Application Publication
(10) Pub. No.: US 2025/0178425 A1
(43) Pub. Date: Jun. 5, 2025

(54) System for Converting an Internal Combustion Engine Vehicle to a Hybrid Vehicle

(71) Applicant: Patrick M. Glance, Pinckney, MI (US)

(72) Inventor: Patrick M. Glance, Pinckney, MI (US)

(21) Appl. No.: 18/965,716

(22) Filed: Dec. 2, 2024

Related U.S. Application Data
(60) Provisional application No. 63/606,505, filed on Dec. 5, 2023.

(51) Int. Cl. B60K 6/40; B60D 1/28; B60K 6/26; B60K 16/00; B60K 26/02; B60Q 1/30

(52) U.S. Cl. CPC B60K 6/40; B60D 1/28; B60K 6/26; B60K 16/00; B60K 26/02; B60Q 1/30; B60K 2016/003

(57) ABSTRACT

A system for converting an internal combustion engine vehicle (ICEV) to a hybrid vehicle is a system that enables an existing ICEV to operate as a hybrid vehicle without requiring major modifications to the ICEV. The system can be attached to existing hitch trailers and towing packages or can be installed as a removable system. The system includes an electric motor, an auxiliary wheel, a wheel controller, an electric power source, an electric accelerator pedal, and a support structure. The electric motor generates the torque to rotate the auxiliary wheel. The wheel controller coordinates the electric motor operation based on the operational signals from the electric accelerator pedal. The electric power source provides the electricity for the electric motor. The electric accelerator pedal enables the user to control the electric motor and the auxiliary wheel. The support structure provides physical support to the individual components of the system.

The current application claims a priority to the U.S. provisional patent application Ser. No. 63/605,505 filed on Dec. 5, 2023.

### FIELD OF THE INVENTION

The present invention relates generally to vehicle technologies and propulsion systems. More specifically, the present invention discloses novel means for converting existing internal combustion engine vehicles into hybrid vehicles.

### BACKGROUND OF THE INVENTION

The current landscape of vehicles generally includes three types of vehicles on the road: Internal Combustion Engine Vehicles (ICEVs), electric vehicles, and hybrid vehicles. Traditional ICEVs have served as a reliable form of transportation due to the widespread availability of gasoline for fuel. However, due to the rising cost of gasoline and growing concerns of the environmental impact of ICEVs, electric vehicles and hybrid vehicles have risen in popularity. Electric vehicles enable the use of electricity to power an electric motor that propels the vehicle. Hybrid vehicles implement both a combustion and electric drive system that takes advantage of the heat generated by the combustion engine to power the electric system. Unfortunately, the option of choosing what type of engine the vehicle uses is limited to the manufacturer, unless the owner decides to pay for a custom job. So, vehicles owners must buy a new vehicle or make a large investment if they intend to switch the type of engine that propels the vehicle.

Therefore, an objective of the present invention is to provide a novel system that facilitates the conversion of an existing ICEV into a hybrid vehicle. The present invention allows an existing ICEV to operate as a hybrid vehicle without requiring major modifications. The present invention caters to the large used-vehicle market to enable used vehicles to continue being environmentally viable to reduce the world's carbon footprint. Additional features and benefits of the present invention are further discussed in the sections below.

### SUMMARY OF THE INVENTION

The present invention discloses a system for converting an internal combustion engine vehicle (ICEV) to a hybrid vehicle. The present invention is preferably provided as a retrofittable system that can be installed on an existing ICEV. For example, the present invention can be provided as a deployable system that can be coupled to the trailer hitch oh the ICEV so that the present invention can propel the ICEV from the rear.

Alternatively, the present invention can be retrofitted with small modifications so that the present invention can be installed under the ICEV's trunk. To do so, the present invention includes a secondary wheel equipped with a corresponding electric motor that is powered independently from the ICEV. The secondary wheel is mounted on a portable frame that can be coupled to the ICEV's trailer hitch. The portable frame is a light structure that allows the secondary wheel to be stored and/or deployed while coupled to the trailer hitch. Further, the portable frame is strong enough to support the different electrical components that enable the independent operation of the electric motor, such as a portable battery, controller, etc.

### BRIEF DESCRIPTION OF THE DRAWINGS

FIG. 1 is a top-front-right perspective view of the present invention.

FIG. 2 is a top-rear-left perspective view of the present invention.

FIG. 3 is a top view of the present invention.

FIG. 4 is a right-side view of the present invention.

FIG. 5 is a cross-sectional view of the present invention taken along line 5-5 in FIG. 4.

FIG. 6 is a right-side view of the present invention, wherein the present invention is shown in a storage configuration.

FIG. 7 is a top-front-left perspective view of an alternate embodiment of the present invention.

FIG. 8 is a top-rear-right perspective view of the alternate embodiment of the present invention.

FIG. 9 is a front view of the alternative embodiment of the present invention.

FIG. 10 is a right-side view of the alternate embodiment of the present invention.

FIG. 11 is a right-side view of the alternate embodiment of the present invention, wherein the present invention is shown raised for a storage configuration.

FIG. 12 is a right-side view of the alternate embodiment of the present invention, wherein the present invention is shown in the storage configuration.

FIG. 13 is a block diagram showing the electrical connections and the electronic connections of the present invention, wherein the electrical connections are shown in solid lines, and wherein the electronic connections are shown in dashed lines.

FIG. 14 is a top-rear-right perspective view of the present invention, wherein the present invention is shown secured to an Internal Combustion Engine Vehicle (ICEV) using the safety tether, and wherein the lockable hitch adapter is shown detached from the ICEV's trailer hitch.

### DETAILED DESCRIPTION OF THE INVENTION

All illustrations of the drawings are for the purpose of describing selected versions of the present invention and are not intended to limit the scope of the present invention.

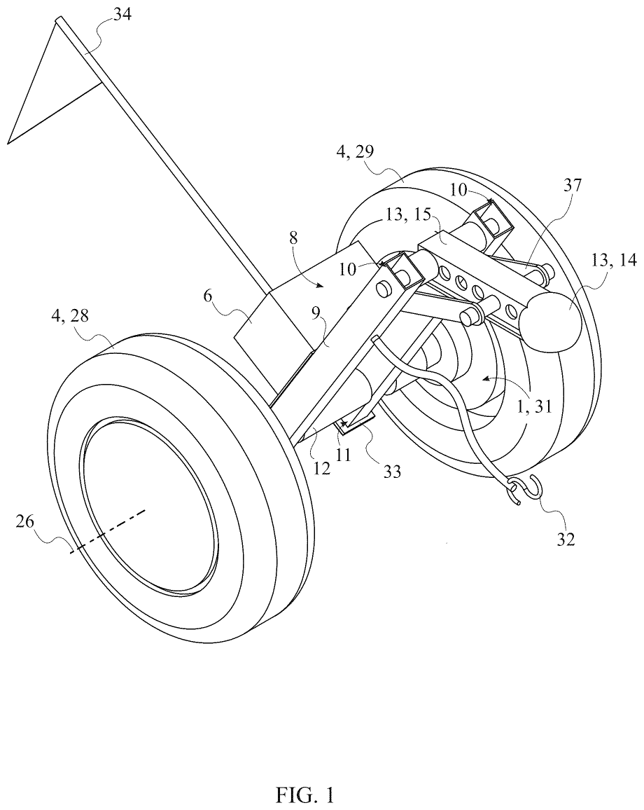

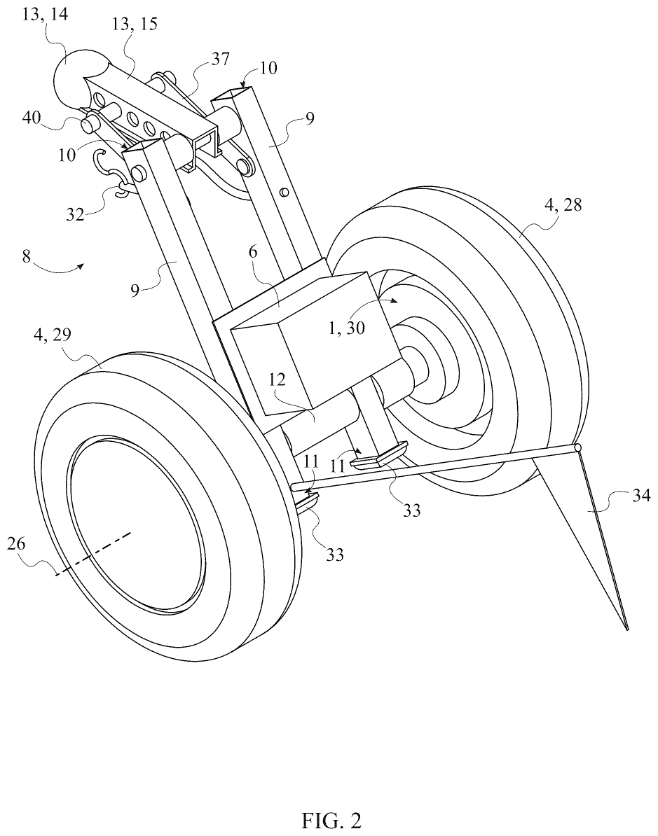

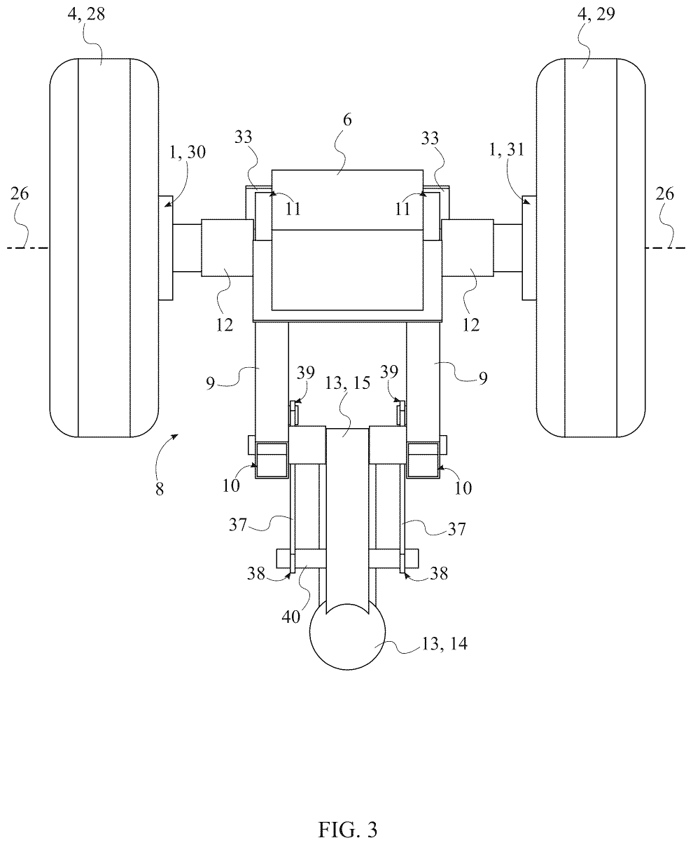

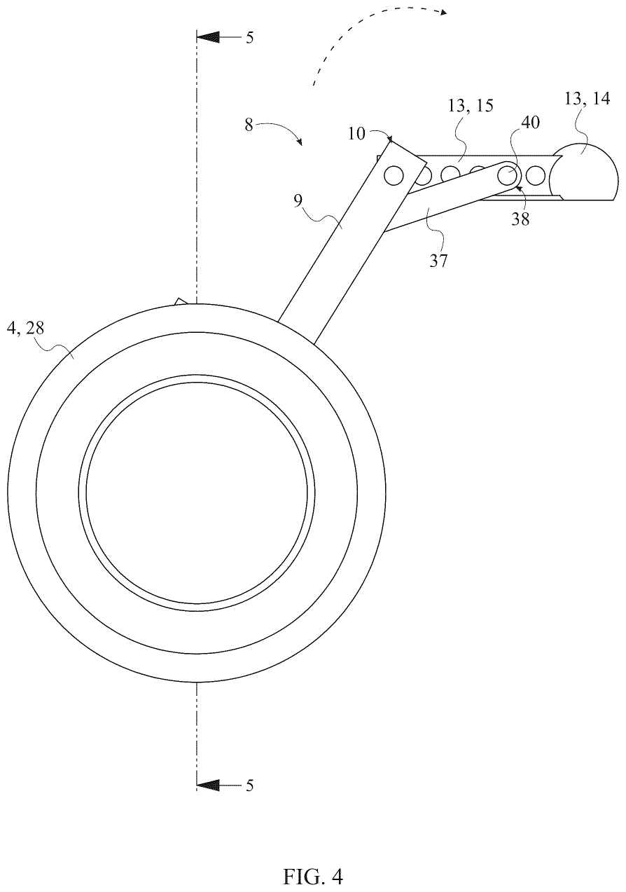

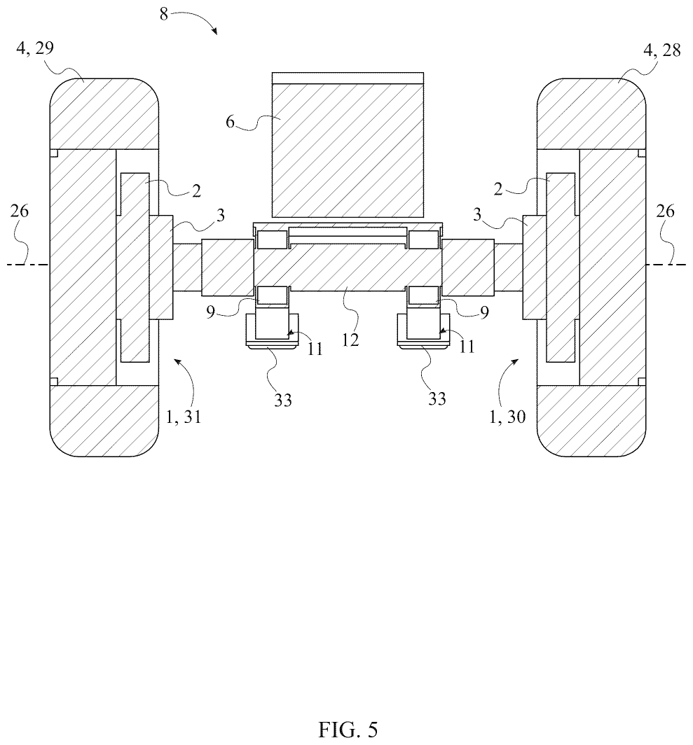

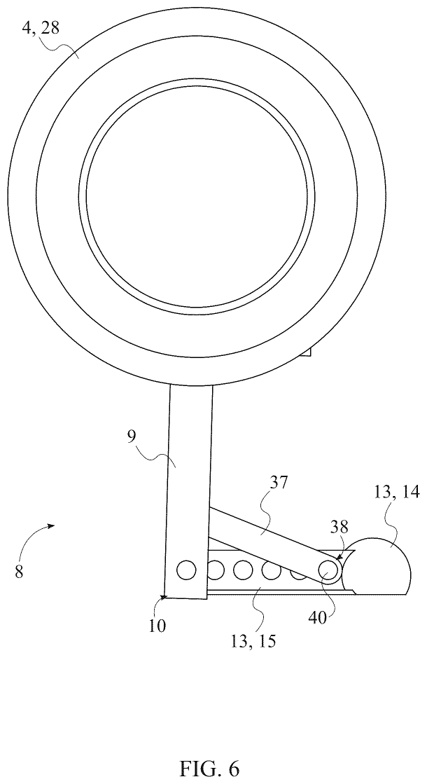

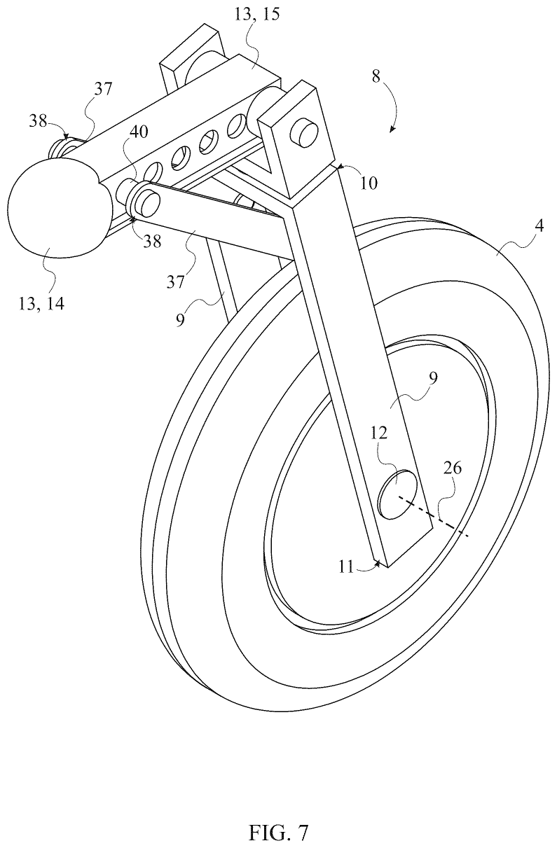

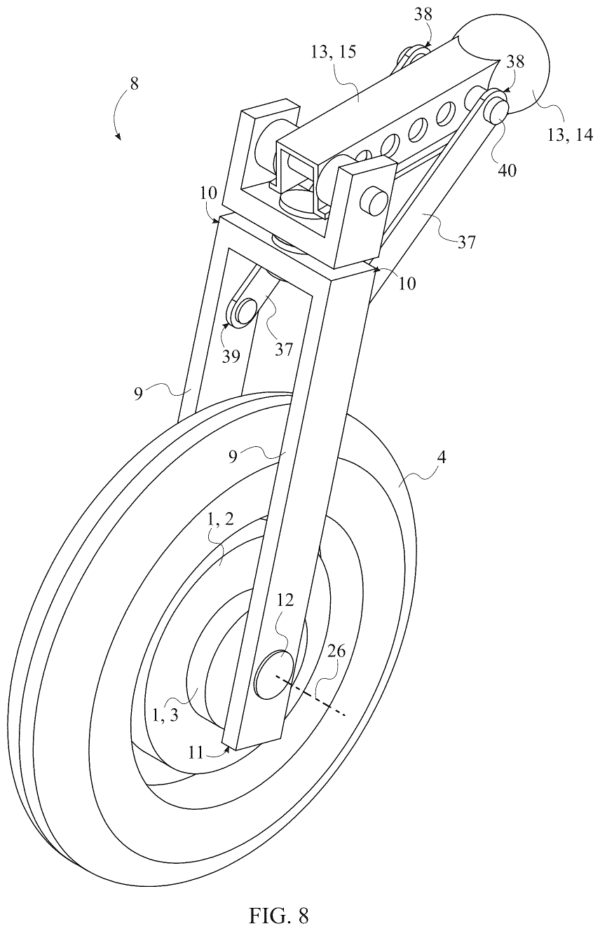

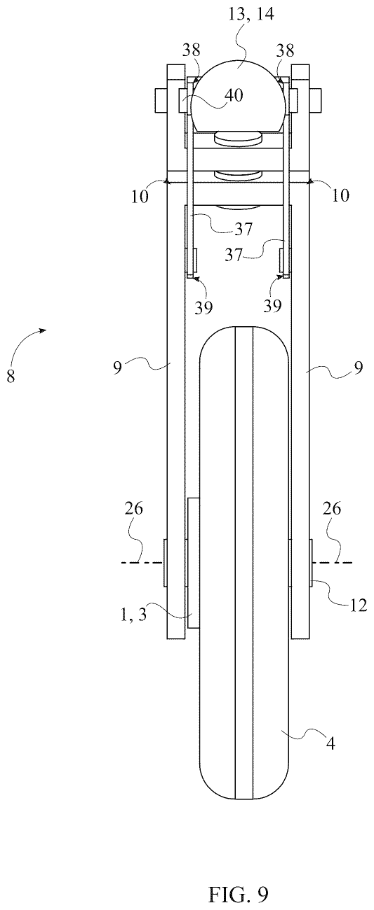

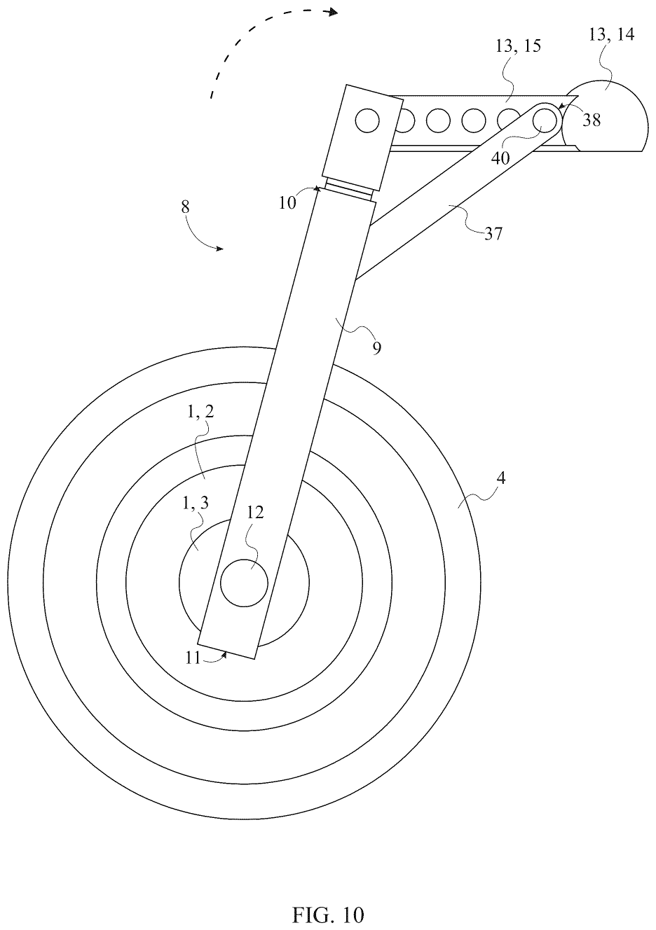

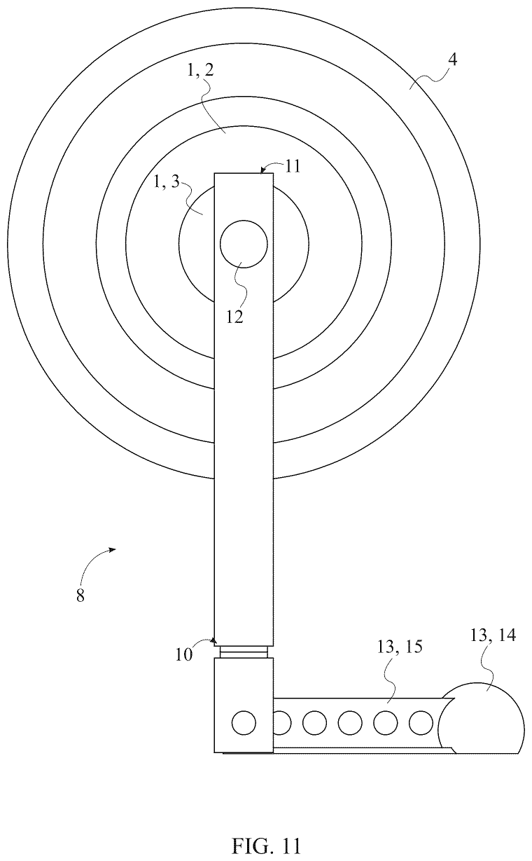

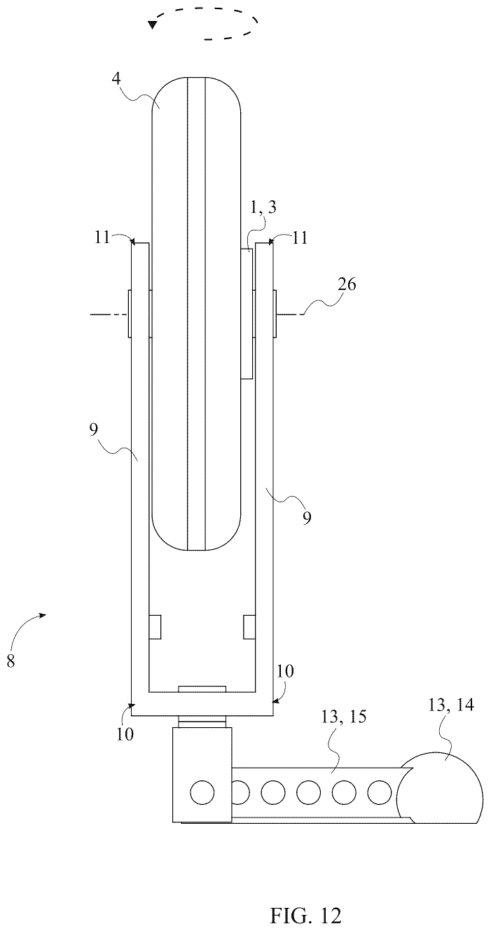

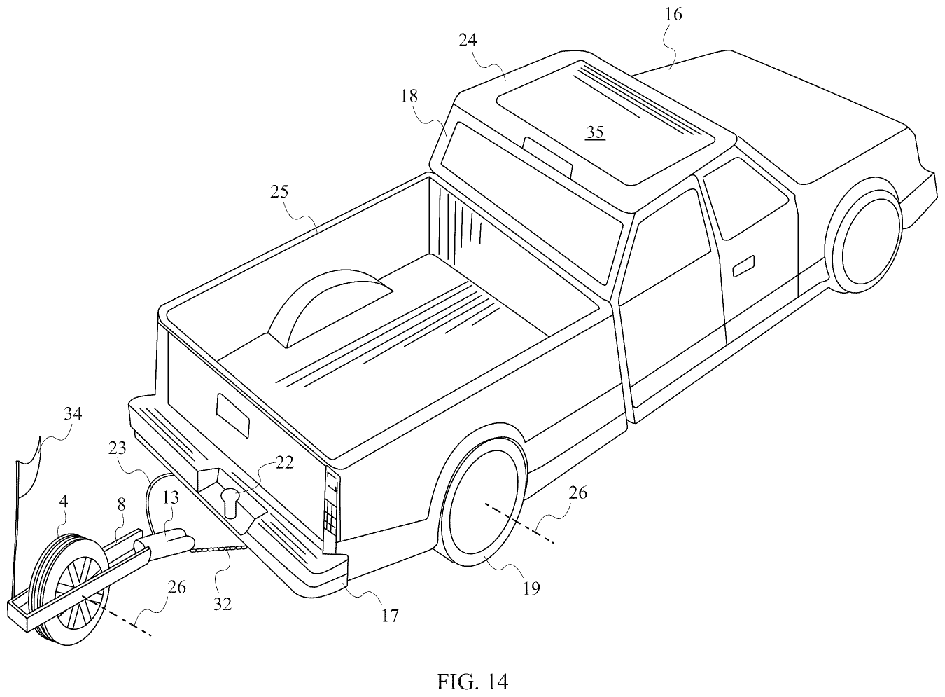

The present invention discloses a system for converting an internal combustion engine vehicle (ICEV) to a hybrid vehicle. The present invention, also referred to as 3^{rd} E-Wheel,” enables an existing ICEV to operate as a hybrid vehicle without requiring major modifications of the structure of the existing ICEV. As can be seen in FIGS. 1 through 14, the present invention comprises at least one electric motor 1, at least one auxiliary wheel 4, a wheel controller 5, an electric power source 6, an electric accelerator pedal 7, and a support structure 8. The at least one electric motor 1 provides the torque necessary to rotate the at least one auxiliary wheel 4 to propel the ICEV 16. The wheel controller 5 enables the automatic operation of the at least one electric motor 1 based on the operational signals transmitted from the electric accelerator pedal 7. The electric power source 6 provides the electricity necessary for the operation of the at least one electric motor 1. The electric accelerator pedal 7 enables the user to remotely operate the at least one electric motor 1 to accelerate and/or decelerate the at least one auxiliary wheel 4. The support structure 8 accommodates the at least one electric motor 1, the at least one auxiliary wheel 4, the wheel controller 5, and the electric power source 6 in a portable manner.

The general configuration of the aforementioned components enables the user to operate an ICEV 16 as a hybrid vehicle. As can be seen in FIGS. 1 through 14, the present invention is designed to be attached to the structural frame of the selected ICEV 16. In general, the ICEV 16 comprises a vehicle chassis 17, a vehicle cabin 18, at least one drive wheel 19, and a pedal cluster 20. The vehicle chassis 17, and the vehicle cabin 18 correspond to the overall support structure 8 that changes depending on the make and model of the ICEV 16. The at least one drivel wheel corresponds to the wheels that propel the ICEV 16 forward using power generated by the combustion engine, and the pedal cluster 20 enables the user to accelerate and decelerate the ICEV 16. Further, the at least one electric motor 1 comprises a rotor 2 and a stator 3. The rotor 2 corresponds to the rotating portion of the at least one electric motor 1, while the stator 3 corresponds to the static portion of the at least one electric motor 1.

In the preferred embodiment, the present invention can be arranged as follows: the support structure 8 is externally mounted to the vehicle chassis 17 to secure the support structure 8 to the ICEV 16, as can be seen in FIGS. 1 through 14. Further, the stator 3, the wheel controller 5, and the power source are mounted onto the support structure 8 to form a single portable structure. The at least one auxiliary wheel 4 is rotatably mounted to the support structure 8 to enable the rotation of the at least one auxiliary wheel 4 while secured to the support structure 8. In addition, a rotation axis 26 of the at least one auxiliary wheel 4 is positioned parallel to a rotation axis 26 of the at least one drive wheel 19 so that the rotation of the at least one auxiliary wheel 4 results in the motion of the ICEV 16 matching the motion generated by the rotation of the at least one drive wheel 19. In other words, the present invention propels the vehicle in the same direction as the drive system of the ICEV 16 would in order to prevent unwanted maneuvers while the user is driving the ICEV 16.

Moreover, the rotor 2 is torsionally connected to the at least one auxiliary wheel 4 in order to transmit the torque generated by the at least one electric motor 1 to the at least one auxiliary wheel 4, as can be seen in FIGS. 1 through 14. The torque generated is strong enough to propel the ICEV 16 to speeds necessary for the ICEV 16 to safely travel. Further, the electric accelerator pedal 7 is mounted within the vehicle cabin 18, adjacent to the pedal cluster 20, so that the electric accelerator pedal 7 is accessible to the user while driving the ICEV 16. This way, the user can engage the at least one electric motor 1 while driving the ICEV 16 in a safe and intuitive manner. Furthermore, the electric accelerator pedal 7 and the electric motor are electronically connected to the wheel controller 5 to enable the transmission of command signals from the electric accelerator pedal 7 to the controller, which generates the appropriate operating signals for the at least one electric motor 1. The electric accelerator pedal 7, the electric motor, and the wheel controller 5 are also electrically connected to the electric power source 6 to receive the power necessary for the operation of each electrical component. In other embodiments, depending on the ICEV 16 design, different arrangements can be implemented to retrofit the present invention to an existing ICEV 16.

As can be seen in FIGS. 1 through 14, to enable the user to keep track of the operation of the present invention while driving the ICEV 16, the present invention may further comprise at least one user interface 27. The at least one user interface 27 can provide visual information about different operational factors of the present invention, such as the conditions of the at least one electric motor 1, the current Revolutions per Minute (RPM) of the at least one auxiliary wheel 4, potential operational errors of the at least one electric motor 1, etc. In addition, the ICEV 16 may further comprise a vehicle dashboard 21 corresponding to the existing dashboard of the ICEV 16. To implement the at least one user interface 27, the at least one user interface 27 is positioned within the vehicle cabin 18 and mounted onto the vehicle dashboard 21 so that the at least one user interface 27 is accessible to the user while driving the ICEV 16. Further, the at least one user interface 27 is electronically connected to the wheel controller 5 to enable the transmission of operational data from the wheel controller 5 to the at least one user interface 27 so that the data is properly displayed to the user. Furthermore, the at least one user interface 27 is electrically connected to the electric power source 6 in such a way that the at least one user interface 27 works independently from the power system of the ICEV 16. In other embodiments, different tools can be provided to help the user remotely track the operation of the present invention.

As previously discussed, the present invention can be removably attached to an existing ICEV 16 without requiring modifications to the ICEV 16. In the preferred embodiment, the present invention is designed to be attached to the trailer hitch 22 of the ICEV 16. As can be seen in FIGS. 1 through 14, the support structure 8 may comprise at least one extension arm 9 and a wheel truss 12. The wheel truss 12 provides support for the at least one auxiliary wheel 4 while enabling the rotation of the at least one auxiliary wheel 4. The wheel truss 12 is a lightweight structure that provides the required structural support to facilitate the operation of the at least one electric motor 1, the at least one auxiliary wheel 4, and the electric power source 6. The at least one extension arm 9 corresponds to the mechanism that facilitates the attachment of the present invention to the trailer hitch 22. The at least one extension arm 9 is preferably an elongated piece of material that offsets the wheel truss 12 from the trailer hitch 22. So, the at least one extension arm 9 may comprise a proximal arm end 10 and a distal arm end 11 corresponding to the terminal ends of the at least one extension arm 9.

In the preferred embodiment, the wheel truss 12 and the at least one extension arm 9 can be implemented as follows: the at least one extension arm 9 is positioned perpendicular the rotation axis 26 of the at least one auxiliary wheel 4 to maintain the rotation axis 26 of the at least one auxiliary wheel 4 parallel to the rotation axis 26 of the at least one drive wheel 19, as can be seen in FIGS. 1 through 14. In addition, the wheel truss 12 is laterally connected to the at least one extension arm 9, adjacent to the distal arm end 11, to secure the wheel truss 12 to the at least one extension arm 9. The connection between the at least one extension arm 9 and the wheel truss 12 can be a permanent connection or a detachable connection that allows the present invention to operate as a modular structure. Further, the at least one auxiliary wheel 4 is rotatably connected into the wheel truss 12 so that the wheel truss 12 can support the rotation of the at least one auxiliary wheel 4 during operation. Furthermore, the proximal arm end 10 is coupled to the trailer hitch 22 to secure the present invention to the ICEV 16 using the at least one extension arm 9.

In order to facilitate the removable attachment of the at least one extension arm 9 to the trailer hitch 22, the support structure 8 may further comprise a lockable hitch adapter 13, as can be seen in FIGS. 1 through 14. The lockable hitch adapter 13 corresponds to a manual adapter that allows the user to securely attach the proximal distal arm to the trailer hitch 22. The lockable hitch adapter 13 is designed to accommodate most trailer hitch 22 is available in the market. So, the lockable hitch adapter 13 may generally comprise a proximal adapter piece 14 and a distal adapter piece 15. The proximal adapter piece 14 corresponds to the portion of the lockable hitch adapter 13 that engages the trailer hitch 22, while the distal adapter piece 15 corresponds to the portion of the lockable hitch adapter 13 that engages the at least one extension arm 9. To implement the lockable hitch adapter 13, the proximal adapter piece 14 is coupled to the trailer hitch 22. This allows the lockable hitch adapter 13 to the trailer hitch 22 in a removable manner so that the user can selectively attach the present invention to the ICEV 16. Further, the distal adapter piece 15 is hingedly connected to the proximal arm end 10, offset from the trailer hitch 22.

As can be seen in FIGS. 1 through 14, the hinged connection between the distal adapter piece 15 and the proximal arm end 10 allows the present invention to be stored away while coupled to the trailer hitch 22 if the user does not want to utilize the present invention. For example, once the lockable hitch adapter 13 is connected to the trailer hitch 22, the user can rotate the support structure 8 upwards about the distal adapter piece 15 until the support structure 8 is positioned against the rear of the ICEV 16. This allows the user to transport the present invention without using the at least one auxiliary wheel 4 on the ICEV 16. Due to the size of the at least one auxiliary wheel 4, the present invention may take up too much space on the ICEV 16 rear which can cause problems to the user while maneuvering the ICEV 16. So, in some embodiments, the proximal arm end 10 is also rotatably mounted to the distal adapter piece 15 in such a way that the entire assembly can be rotated before being positioned against the rear of the ICEV 16. This allows the present invention to take up less space on the rear of the ICEV 16 when not in use. In other embodiments, a motorized deployment mechanism can be implemented at the hinged joints of the at least one extension arm 9 that automatically deploys/stores the at least one auxiliary wheel 4. The motorized deployment mechanism can be controlled via the at least one user interface 27 so that the user can selectively deploy and/or store the at least one auxiliary wheel 4 while driving the ICEV 16. In other embodiments, different mechanisms can be implemented that facilitate the storage and deployment of the present invention.

The present invention may need additional power to propel the desired ICEV 16, specially for heavier ICEVs 16. As can be seen in FIGS. 1 through 6 and 13, the additional electric motors and auxiliary wheels may be necessary to propel the ICEV 16. In some embodiments, the at least one auxiliary wheel 4 may include a first auxiliary wheel 28 and a second auxiliary wheel 29. Likewise, the at least one electric motor 1 may include a first electric motor 30 and a second electric motor 31. By providing two auxiliary wheels and two electric motors, the present invention can provide additional torque to propel the desired ICEV 16. To accommodate the additional auxiliary wheels and electric motors, the support structure 8 is positioned in between the first electric motor 30 and the second electric motor 31. This enables the load from the support structure 8 to be evenly distributed on the first auxiliary wheel 28 and the second auxiliary wheel 29. Further, the rotor 2 of the first electric motor 30 is torsionally connected to the first auxiliary wheel 28, while the rotor 2 of the first electric motor 30 is torsionally connected to the first auxiliary wheel 28. Thus, the first electric motor 30 drives the first auxiliary wheel 28, while the second electric motor 31 drives the second auxiliary wheel 29. In other embodiments, different arrangements can be implemented to accommodate the additional auxiliary wheels and electric motors.

As can be seen in FIGS. 1, 2, and 14, to improve the safety of the present invention, the present invention may further comprise a safety tether 32. The safety tether 32 provides a fail-safe feature for the present invention in case the lockable hitch adapter 13 fails and the at least one extension arm 9 uncouples from the trailer hitch 22. The safety tether 32 can include different tethers strong enough to keep the present invention connected to the vehicle chassis 17 including, but not limited to, a safety chain, a safety wire, etc. In general, the safety tether 32 is connected in between the support structure 8 and the vehicle chassis 17 to provide an additional safety connection between the present invention and the vehicle chassis 17. The safety tether 32 can be secured to different portions of the vehicle chassis 17 including, but not limited to, the trailer hitch 22. In other embodiments, different safety features can be implemented that prevent accidental decoupling of the present invention from the ICEV 16.

Due to the attachment of the present invention to the rear of the ICEV 16, the present invention can include different safety maneuvering features for other drivers to be aware of the presence of the present invention. As can be seen in FIGS. 1, 2, and 14, in some embodiments, the present invention may further comprise at least one auxiliary brake light 33 that indicates other drivers when the user's ICEV 16 is decelerating. To accommodate the at least one auxiliary brake light 33, the ICEV 16 may further comprise a trailer light socket 23. The at least one auxiliary brake light 33 is mounted onto the support structure 8 opposite the rear of the ICEV 16. This way, the at least one auxiliary brake light 33 is visible to the other drivers around the user. In addition, the at least one auxiliary brake light 33 is electrically connected to the trailer light socket 23 so that the at least one auxiliary brake light 33 is activated when the user steps on the brake pedal of the ICEV 16. In another embodiment, the present invention may further comprise at least one safety flag 34 that provides a visual indicator for the other drivers to recognize the presence of the present invention trailing the user's ICEV 16. The at least one safety flag 34 is mounted onto the support structure 8, also opposite the rear of the ICEV 16, so that the at least one safety flag 34 is clearly visible to the other drivers. In other embodiments, additional road safety features can be implemented.

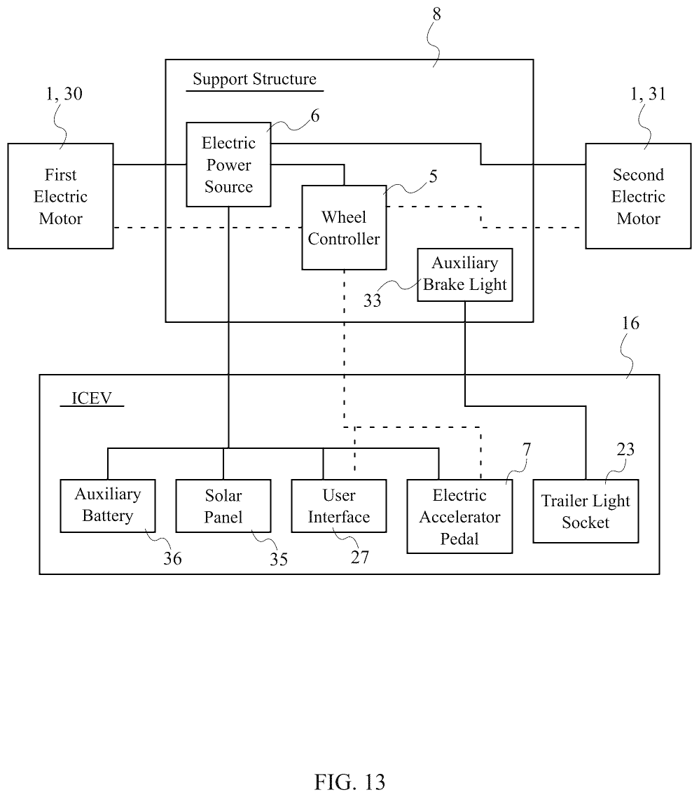

As can be seen in FIG. 13, the continuous operation of the present invention may require additional electrical power that the electric power source 6 may provide, such as during long drives. So, in some embodiments, the present invention may further comprise at least one solar panel 35 that can be mounted on the ICEV 16, such as the vehicle roof 24. The at least one solar panel 35 is designed to recharge the electric power source 6 while coupled to the vehicle chassis 17. To do so, the at least one solar panel 35 is mounted onto the vehicle roof 24 to secure the at least one solar panel 35 to the ICEV 16. In addition, the at least one solar panel 35 is electrically connected to the electric power source 6 to transmit the electricity generated by the at least one solar panel 35 to the electric power source 6.

Alternate to the at least one solar panel 35, additional storage devices may be implemented to supply additional power to the present invention once the electric power source 6 is depleted. As can be seen in FIG. 13, the present invention may further comprise at least one auxiliary battery 36. The at least one auxiliary battery 36 can be carried on the ICEV 16 to prolong the operation of the present invention. The at least one auxiliary battery 36 can be positioned in different spaces on the ICEV 16, such as the storage space 25 of the ICEV 16. To implement the at least one auxiliary battery 36, the at least one auxiliary battery 36 is mounted within the storage space 25 so that the at least one auxiliary battery 36 is safely transported on the ICEV 16. Further, the at least one auxiliary battery 36 is electrically connected to the electric power source 6 to power the present invention once the electric power source 6 is depleted. In other embodiments, different power sources can be implemented that prolong the operation of the present invention.

The present invention can be easily operated by turning the ICEV 16 on and switching the gear to neutral. This way, while the present invention is activated, the user is still able to utilize the power steering, power brakes, power windows, radio, heater, cooling, lighting, and other systems of the ICEV 16. The vehicle running neutral is a relatively low emissions condition. In addition, the user can utilize the ICEV 16 without the ICEV 16 being turned on by simply placing the gearshift in to drive or reverse positions. In this case, the present invention is placed neutral or raised off the ground. The trailer hitch 22 could be equipped with a security lock as well as an anti-theft lock to prevent the present invention from being stolen. When stored away, the overall length is reduced to approximately two feet. Further, the overall length increase is reduced to approximately one foot when the present invention is folded up and turned flat and parallel with the bumper. In another embodiment, the present invention could be integrated below the trunk of the ICEV 16 so that the present invention does not protrude behind the rear of the ICEV 16. However, this alternative requires greater vehicle modifications to accommodate the at least one electric motor 1 and the at least one auxiliary wheel 4. To do so, an undercarriage space is implemented behind the vehicle rear wheels adjacent to the rear bumper. A suspension system can also be implemented to prevent damage to the vehicle chassis 17 while the ICEV 16 is in motion. In other embodiments, different arrangements can be implemented that integrate the present invention into the vehicle chassis 17.

Although the invention has been explained in relation to its preferred embodiment, it is to be understood that many other possible modifications and variations can be made without departing from the spirit and scope of the invention.

What is claimed is:

1. A system for converting an internal combustion engine vehicle (ICEV) to a hybrid vehicle, the system comprising:
at least one electric motor;
at least one auxiliary wheel;
a wheel controller;
an electric power source;
an electric accelerator pedal;
a support structure;
the ICEV comprising a vehicle chassis, a vehicle cabin, at least one drive wheel, and a pedal cluster;
the at least one electric motor comprising a rotor and a stator;
the support structure being externally mounted to the vehicle chassis;
the stator, the wheel controller, and the power source being mounted onto the support structure;
the at least one auxiliary wheel being rotatably mounted to the support structure;
a rotation axis of the at least one auxiliary wheel being positioned parallel to a rotation axis of the at least one drive wheel;
the rotor being torsionally connected to the at least one auxiliary wheel;
the electric accelerator pedal being mounted within the vehicle cabin, adjacent to the pedal cluster;
the electric accelerator pedal and the electric motor being electronically connected to the wheel controller; and
the electric accelerator pedal, the electric motor, and the wheel controller being electrically connected to the electric power source.

2. The system as claimed in claim 1 further comprising:
at least one user interface;
the ICEV further comprising a vehicle dashboard;
the at least one user interface being positioned within the vehicle cabin;
the at least one user interface being mounted onto the vehicle dashboard;
the at least one user interface being electronically connected to the wheel controller; and
the at least one user interface being electrically connected to the electric power source.

3. The system as claimed in claim 1 further comprising:
the support structure comprising at least one extension arm and a wheel truss;
the ICEV further comprising a trailer hitch;
the at least one extension arm comprising a proximal arm end and a distal arm end;
the at least one extension arm being positioned perpendicular the rotation axis of the at least one auxiliary wheel;
the wheel truss being laterally connected to the at least one extension arm, adjacent to the distal arm end;
the at least one auxiliary wheel being rotatably connected into the wheel truss; and
the proximal arm end being coupled to the trailer hitch.

4. The system as claimed in claim 3 further comprising:
the support structure further comprising a lockable hitch adapter;
the lockable hitch adapter comprising a proximal adapter piece and a distal adapter piece;
the proximal adapter piece being coupled to the trailer hitch; and
the distal adapter piece being hingedly connected to the proximal arm end, offset from the trailer hitch.

5. The system as claimed in claim 4, wherein the proximal arm end is rotatably mounted to the distal adapter piece.

6. The system as claimed in claim 1 further comprising:
the at least one auxiliary wheel being a first auxiliary wheel and a second auxiliary wheel;
the at least one electric motor being a first electric motor and a second electric motor;
the support structure being positioned in between the first electric motor and the second electric motor;
the rotor of the first electric motor being torsionally connected to the first auxiliary wheel; and
the rotor of the first electric motor being torsionally connected to the first auxiliary wheel.

7. The system as claimed in claim 1 further comprising:
a safety tether; and
the safety tether being connected in between the support structure and the vehicle chassis.

8. The system as claimed in claim 1 further comprising:
at least one auxiliary brake light;
the ICEV further comprising a trailer light socket;
the at least one auxiliary brake light being mounted onto the support structure; and
the at least one auxiliary brake light being electrically connected to the trailer light socket.

9. The system as claimed in claim 1 further comprising:
at least one safety flag; and
the at least one safety flag being mounted onto the support structure.

10. The system as claimed in claim 1 further comprising:
at least one solar panel;
the ICEV further comprising a vehicle roof;
the at least one solar panel being mounted onto the vehicle roof; and
the at least one solar panel being electrically connected to the electric power source.

11. The system as claimed in claim 1 further comprising:
at least one auxiliary battery;
the ICEV further comprising a storage space;
the at least one auxiliary battery being mounted within the storage space; and
the at least one auxiliary battery being electrically connected to the electric power source.

12. A system for converting an internal combustion engine vehicle (ICEV) to a hybrid vehicle, the system comprising:
at least one electric motor;
at least one auxiliary wheel;
a wheel controller;
an electric power source;
an electric accelerator pedal;
a support structure;
the ICEV comprising a vehicle chassis, a vehicle cabin, at least one drive wheel, a pedal cluster, and a trailer hitch;
the at least one electric motor comprising a rotor and a stator;
the support structure comprising at least one extension arm and a wheel truss;
the at least one extension arm comprising a proximal arm end and a distal arm end;
the stator, the wheel controller, and the power source being mounted onto the wheel truss;
the at least one extension arm being positioned perpendicular the rotation axis of the at least one auxiliary wheel;
the wheel truss being laterally connected to the at least one extension arm, adjacent to the distal arm end;
the at least one auxiliary wheel being rotatably connected into the wheel truss;
the proximal arm end being coupled to the trailer hitch;
a rotation axis of the at least one auxiliary wheel being positioned parallel to a rotation axis of the at least one drive wheel;
the rotor being torsionally connected to the at least one auxiliary wheel;
the electric accelerator pedal being mounted within the vehicle cabin, adjacent to the pedal cluster;
the electric accelerator pedal and the electric motor being electronically connected to the wheel controller; and
the electric accelerator pedal, the electric motor, and the wheel controller being electrically connected to the electric power source.

13. The system as claimed in claim 12 further comprising:
at least one user interface;
the ICEV further comprising a vehicle dashboard;
the at least one user interface being positioned within the vehicle cabin;
the at least one user interface being mounted onto the vehicle dashboard;
the at least one user interface being electronically connected to the wheel controller; and
the at least one user interface being electrically connected to the electric power source.

14. The system as claimed in claim 12 further comprising:
the support structure further comprising a lockable hitch adapter;
the lockable hitch adapter comprising a proximal adapter piece and a distal adapter piece;
the proximal adapter piece being coupled to the trailer hitch; and
the distal adapter piece being hingedly and rotatably connected to the proximal arm end, offset from the trailer hitch.

15. The system as claimed in claim 12 further comprising:
the at least one auxiliary wheel being a first auxiliary wheel and a second auxiliary wheel;
the at least one electric motor being a first electric motor and a second electric motor;
the support structure being positioned in between the first electric motor and the second electric motor;
the rotor of the first electric motor being torsionally connected to the first auxiliary wheel; and
the rotor of the first electric motor being torsionally connected to the first auxiliary wheel.

16. The system as claimed in claim 12 further comprising:
a safety tether; and
the safety tether being connected in between the support structure and the vehicle chassis.

17. The system as claimed in claim 12 further comprising:
at least one auxiliary brake light;
the ICEV further comprising a trailer light socket;
the at least one auxiliary brake light being mounted onto the support structure; and
the at least one auxiliary brake light being electrically connected to the trailer light socket.

18. The system as claimed in claim 12 further comprising:
at least one safety flag; and
the at least one safety flag being mounted onto the support structure.

19. The system as claimed in claim 12 further comprising:
at least one solar panel;
the ICEV further comprising a vehicle roof;
the at least one solar panel being mounted onto the vehicle roof; and
the at least one solar panel being electrically connected to the electric power source.

20. The system as claimed in claim 12 further comprising:
at least one auxiliary battery;
the ICEV further comprising a storage space;
the at least one auxiliary battery being mounted within the storage space; and
the at least one auxiliary battery being electrically connected to the electric power source.
